(19) United States
(12) Patent Application Publication
(10) Pub. No.: US 2021/0189182 A1
(43) Pub. Date: Jun. 24, 2021

(54) ADHESIVE FILM AND LAMINATE FILM INCLUDING THE SAME

(71) Applicant: INNOX ADVANCED MATERIALS CO., LTD., Asan-si (KR)

(72) Inventors: Jong Geol LEE, Asan-si (KR); Jong Hoon LEE, Asan-si (KR); Myung Sup JUNG, Asan-si (KR); Jae Hyeon CHO, Asan-si (KR)

(21) Appl. No.: 17/126,769

(22) Filed: Dec. 18, 2020

(30) Foreign Application Priority Data
Dec. 20, 2019 (KR) 10-2019-0171708

(51) Int. Cl. C09J 7/20; C09J 9/00; C09J 7/40

(52) U.S. Cl. CPC C09J 7/20; C09J 9/00; C09J 2301/30; C09J 2301/122; C09J 7/40

(57) ABSTRACT

An adhesive film and a laminate film including the same are disclosed. The adhesive film contains an adhesive resin and a near-infrared ray blocking agent, wherein visible-ray transmittance of the adhesive film in a wavelength band of 400 to 700 nm is in a range of 80 to 95%, and near-infrared ray transmittance of the adhesive film in a wavelength band of 800 to 1,500 nm is in a range of 10 to 70%.

### CROSS-REFERENCE TO RELATED APPLICATION

This application claims a benefit under 35 U.S.C. § 119(a) of Korean Patent Application No. 10-2019-0171708 filed on Dec. 20, 2019, on the Korean Intellectual Property Office, the entire disclosure of which is incorporated herein by reference for all purposes.

### BACKGROUND

### 1. Field

The present disclosure relates to an adhesive film and a laminate film including the same. More specifically, an adhesive film having both visible-ray transmittance and near-infrared ray transmittance at a level suitable for a specific application, and a laminate film including the same are disclosed herein.

### 2. Description of Related Art

Recently, in a display industry, a laminate film excellent in both visible-ray transmittance and near-infrared ray transmittance is required.

However, conventionally, laminate films with excellent visible-ray transmittance and near-infrared ray transmittance at a low wavelength band (800 to 1,000 nm) have been developed. However, a laminate film that has not only excellent visible-ray transmittance and overall near-infrared ray transmittance, but also has excellent near-infrared ray transmittance at a high wavelength band (above 1,000 nm and below 1,500 nm) has not existed. Thus, demand for such a laminate film has not been clearly revealed so far.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of one embodiment of the present disclosure is to provide an adhesive film having excellence in both of visible-ray transmittance and near-infrared ray transmittance.

A purpose of another embodiment of the present disclosure is to provide a laminate film including the adhesive film.

Purposes of the present disclosure are not limited to the above-mentioned purpose. Other purposes and advantages of the present disclosure as not mentioned above may be understood from following descriptions and more clearly understood from embodiments of the present disclosure. Further, it will be readily appreciated that the purposes and advantages of the present disclosure may be realized by features and combinations thereof as disclosed in the claims.

One aspect of the present disclosure provides an adhesive film containing an adhesive resin and a near-infrared ray blocking agent, wherein visible-ray transmittance of the adhesive film in a wavelength band of 400 to 700 nm is in a range of 80 to 95%, and near-infrared ray transmittance of the adhesive film in a wavelength band of 800 to 1,500 nm is in a range of 10 to 70%.

In one embodiment of the adhesive film, near-infrared ray transmittance of the adhesive film in a wavelength band of above 1,000 nm and below 1,500 nm is in a range of 5 to 69%.

In one embodiment of the adhesive film, near-infrared ray transmittance of the adhesive film in a wavelength band of 800 to 1,000 nm is in a range of 15 to 75%.

In one embodiment of the adhesive film, the adhesive resin includes a urethane resin, an acrylic resin, an epoxy resin, a silicone resin, or combinations thereof.

In one embodiment of the adhesive film, an average particle diameter of the near-infrared ray blocking agent is in a range of 10 to 100 nm.

In one embodiment of the adhesive film, the near-infrared ray blocking agent contains 0.5 to 8 parts by weight of tungsten oxide based on 100 parts by weight of the adhesive resin.

In one embodiment of the adhesive film, the tungsten oxide includes CWO (cesium-doped WO₃), WO₃, or a combination thereof.

In one embodiment of the adhesive film, the near-infrared ray blocking agent further contains 0.1 to 0.5 parts by weight of a near-infrared ray blocking additive selected from a group consisting of an organic near-infrared ray blocking additive and an inorganic near-infrared ray blocking additive, based on 100 parts by weight of the adhesive resin.

Another aspect of the present disclosure provides a laminate film comprising the adhesive film as defined above.

In one embodiment of the laminate film, the laminate film may comprise a pair of release films including a first release film disposed on one face of the adhesive film and a second release film disposed on an opposite face of the adhesive film to one face.

In one embodiment of the laminate film, each of the first and second release films includes polyethylene terephthalate (PET), triacetyl cellulose (TAC), cycloolefin polymer (COP), polycarbonate (PC), polyethersulfone (PES), polypropylene (PP), acrylic, or combinations thereof.

In one embodiment of the laminate film, a peel force between the adhesive film and each of the release films is in a range of 1 to 20 gf/inch.

In one embodiment of the laminate film, the laminate film further comprises a release film disposed on one face of the adhesive film, and a transparent base film disposed on an opposite face thereof to one face.

In one embodiment of the laminate film, the transparent base film includes polyethylene terephthalate (PET), triacetyl cellulose (TAC), cycloolefin polymer (COP), polycarbonate (PC), polyethersulfone (PES), polypropylene (PP), acrylic, or combinations thereof.

In one embodiment of the laminate film, the transparent base film has an anti-fog coating.

In one embodiment of the laminate film, the laminate film is applicable to an outdoor display or a vehicle.

The adhesive film according to the present disclosure not only has excellent visible-ray transmittance and overall near-infrared ray transmittance. Further, the adhesive film according to the present disclosure has excellent near-infrared ray transmittance in a high wavelength band (above 1,000 nm and below 1,500 nm) and thus may be effectively applied to displays for specific purposes.

In addition to the effects as described above, specific effects of the present disclosure will be described together with the detailed description for carrying out the disclosure.

### BRIEF DESCRIPTION OF DRAWINGS

FIG. 1 is a cross-sectional view of a laminate film according to a first embodiment of the present disclosure.

FIG. 2 is a cross-sectional view of a laminate film according to a second embodiment of the present disclosure.

FIG. 3 is a graph showing optical transmittance of each of adhesive films in Examples 2 and 5.

### DETAILED DESCRIPTIONS

For simplicity and clarity of illustration, elements in the figures are not necessarily drawn to scale. The same reference numbers in different figures denote the same or similar elements, and as such perform similar functionality. Moreover, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

The terms “about”, “substantially”, etc. in the present disclosure are used to indicate inherent preparation and substance related tolerance. This is intended to prevent an unscrupulous infringer to design around accurate or absolute values set forth to aid understanding of the present disclosure. The term “step of ˜” used throughout the present disclosure does not mean “step for ˜”.

Throughout the present disclosure, the term “combination thereof” included in expression of a Makushi form means a mixture or combination of at least two selected from a group consisting of elements as recited in the expression of the Makushi form.

Hereinafter, an adhesive film according to one embodiment of the present disclosure will be described in detail.

As used herein, the phrase “visible-ray transmittance” refers to a value obtained by measuring transmittances at wavelengths in a wavelength band of 400 to 700 nm using a UV-Vis-NIR spectrometer (Jasco, V670) and then averaging the transmittances.

Further, as used herein, the phrase “near-infrared ray transmittance” refers to a value obtained by measuring transmittances at wavelengths in a specific wavelength band of 800 to 1,500 nm using a UV-Vis-NIR spectrometer (Jasco, V670), and then averaging the transmittances.

Further, as used herein, “product substituted with a hydrophilic group of substance A” means substance obtained by substituting a hydrogen atom in substance A with a hydrophilic group.

Further, as used herein, “hydrophilic group” refers to —OH, —COOH, —NH₂, —NH₄, —SO₃H, —SO₃, —OSO₃H, —OPO₃H₂ or a combination thereof.

The adhesive film according to one embodiment of the present disclosure has a visible-ray transmittance of 80 to 95% in a wavelength band of 400 to 700 nm, and a near-infrared ray transmittance of 10 to 70% in a wavelength band of 800 to 1,500 nm. Therefore, the adhesive film may be effectively applied to technical fields that require the visible-ray transmittance of 80 to 95% in a wavelength band of 400 to 700 nm, and the near-infrared ray transmittance of 10 to 70% in a wavelength band of 800 to 1,500 nm.

The adhesive film may have a near-infrared ray transmittance of 5 to 69% in a wavelength band of above 1,000 nm and below 1,500 nm. Therefore, the adhesive film may be effectively applied to technical fields that require the visible-ray transmittance of 80 to 95% in a wavelength band of 400 to 700 nm, and the near-infrared ray transmittance of 10 to 70% in a wavelength band of 800 to 1,500 nm, and the near-infrared ray transmittance of 5 to 69% in a wavelength band of above 1,000 nm and below 1,500 nm.

Further, the adhesive film may have a near-infrared ray transmittance of 15 to 75% of a wavelength band of 800 to 1,000 nm. Therefore, the adhesive film may be effectively applied to technical fields that require the visible-ray transmittance of 80 to 95% in a wavelength band of 400 to 700 nm, the near-infrared ray transmittance of 15 to 75% of a wavelength band of 800 to 1,000 nm, and the near-infrared ray transmittance of 10 to 70% in a wavelength band of 800 to 1,500 nm.

Further, the adhesive film may include an adhesive resin and a near-infrared ray blocking agent.

The adhesive resin may include a urethane resin, an acrylic resin, an epoxy resin, a silicone resin, or combinations thereof.

The urethane resin may include urethane(meth)acrylate, 1,2-polybutadiene terminal urethane(meth)acrylate, 1,4-polybutadiene terminal urethane(meth)acrylate, polyester-based urethane(meth)acrylate, polyether-based urethane(meth)acrylate, products substituted with hydrophilic group thereof, hydrogenated products thereof, or combinations thereof,

The urethane(meth)acrylate may be prepared by reacting polyisocyanate, polyol and(meth)acrylic acid.

The polyisocyanate may include 2,4-tolylene diisocyanate, 2,6-tolylene diisocyanate, 4,4′-diphenylmethane diisocyanate, m-phenylene diisocyanate, xylylene diisocyanate, tetramethylene diisocyanate, hexamethylene diisocyanate, lysine diisocyanate ester, 1,4-cyclohexylene diisocyanate, 4,4′-dicyclohexylmethane diisocyanate, 3,3′-dimethyl-4,4′-biphenylenediisocyanate, or combinations thereof.

The polyol may include polyesterdiol, polyetherdiol, polycaprolactonediol, polycarbonate diol, or combinations thereof.

The acrylic resin may include monofunctional (meth)acrylate, polyfunctional (meth)acrylate, or combinations thereof.

The monofunctional (meth)acrylate may include methyl(meth)acrylate, ethyl(meth)acrylate, propyl(meth)acrylate, butyl(meth)acrylate, 2-ethylhexyl(meth)acrylate, isooctyl(meth)acrylate, isodecyl(meth)acrylate, lauryl(meth)acrylate, stearyl(meth)acrylate, phenyl(meth)acrylate, cyclohexyl(meth)acrylate, dicyclopentanyl(meth)acrylate, dicyclopentenyl(meth)acrylate, dicyclopentenyloxyethyl(meth)acrylate, isobornyl(meth)acrylate, methoxylated cyclodecatrien(meth)acrylate, 2-hydroxyethyl(meth)acrylate, 2-hydroxypropyl(meth)acrylate, 3-hydroxypropyl(meth)acrylate, 4-hydroxybutyl(meth)acrylate, tetrahydrofurfuryl(meth)acrylate, 2-hydroxy-3-phenoxypropyl(meth)acrylate, glycidyl(meth)acrylate, caprolactone-modified tetrahydrofurfuryl(meth)acrylate, 3-chloro-2-hydroxypropyl(meth)acrylate, N,N-dimethylaminoethyl (meth)acrylate, N,N-diethylaminoethyl(meth)acrylate, t-butylaminoethyl(meth)acrylate, ethoxycarbonylmethyl(meth)acrylate, phenol ethylene oxide modified acrylate, phenol(ethylene oxide 2 mol modified)acrylate, phenol(ethylene oxide 4 mole modified)acrylate, paracumylphenolethylene oxide modified acrylate, nonylphenol ethylene oxide modified acrylate, nonylphenol(ethylene oxide 4 mole modified)acrylate, nonylphenol(ethylene oxide 8 mole modified)acrylate, nonylphenol(propylene oxide 2.5 mole modified)acrylate, 2-ethylhexylcarbitol acrylate, ethylene oxide-modified phthalic acid(meth)acrylate, ethylene oxide-modified succinic acid(meth)acrylate, trifluoroethyl(meth)acrylate, acrylic acid, methacrylic acid, maleic acid, fumaric acid, ω-carboxy-polycaprolactone mono(meth)acrylate, monohydroxyethyl phthalate(meth)acrylate, (meth)acrylic acid dimer, β-(meth)acryloyloxyethylhydrogensuccinate, n-(meth)acryloyloxyalkylhexahydrophthalimide, products substituted with hydrophilic group thereof, or combinations thereof.

The multifunctional (meth)acrylate may include a bifunctional(meth)acrylate, a trifunctional(meth)acrylate, a tetrafunctional(meth)acrylate or higher multi-functional(meth)acrylate, or combinations thereof.

The bifunctional (meth)acrylate may include 1,3-butylene glycol di(meth)acrylate, 1,4-butanediol di(meth)acrylate, 1,6-hexadiol di(meth)acrylate, 1,9-nonandiol di(meth)acrylate, neopentyl glycol di(meth)acrylate, dicyclopentanyldi(meth)acrylate, 2-ethyl-2-butyl-propanediol(meth)acrylate, neopentyl glycol-modified trimethylolpropanedi(meth)acrylate, stearic acid-modified pentaerythritol diacrylate, polypropylene glycol di(meth)acrylate, 2,2-bis(4-(meth)acryloxydiethoxyphenyl)propane, 2,2-bis(4-(meth)acryloxypropoxyphenyl)propane, 2,2-bis(4-(meth)acryloxytetraethoxyphenyl)propane, products substituted with hydrophilic group thereof, or combinations thereof.

The trifunctional (meth)acrylate may include trimethylolpropane tri(meth)acrylate, tris[(meth)acryloxyethyl]isocyanurate, products substituted with hydrophilic group thereof, or combinations thereof.

The tetrafunctional(meth)acrylate or higher multi-functional(meth)acrylate, may include dimethylolpropane tetra(meth)acrylate, pentaerythritol tetra(meth)acrylate, pentaerythritol ethoxytetra(meth)acrylate, dipentaerythritol penta(meth)acrylate, dipentaerythritol hexa(meth)acrylate, products substituted with hydrophilic group thereof, or combinations thereof.

The epoxy resin may include a bisphenol-based epoxy resin, a biphenyl-based epoxy resin, a naphthalene-based epoxy resin, a florene-based epoxy resin, a phenol novolak-based epoxy resin, a cresol novolak-based epoxy resin, a trishydroxylphenylmethane-based epoxy resin, a tetraphenylmethane-based epoxy resin, or combinations thereof. In this case, the bisphenol-based epoxy resin may include a bisphenol A type epoxy resin, a bisphenol F type epoxy resin, a bisphenol S type epoxy resin, a hydrogenated bisphenol A type epoxy resin, and a bisphenol AF type epoxy resin. Currently commercially available epoxy resin products may include, as bisphenol A type epoxy resins, YD-020, YD-020L, YD-019K, YD-019, YD-017H, YD-017R, YD-017, YD-014, YD-014ER, YD-013K, YD-012, YD-011H, YD-011S, YD-011, etc. from Kukdo Chemical; as cresol novolak-based epoxy resin, YDCN-500-80PCA60, YDCN-500-80PBC60, YDCN-500-90PA75, YDCN-500-90P, YDCN-500-80P, YDCN-500-10P, YDCN-500-8P, YDCN-500-7P, YDCN-500-5P, YDCN-500-4P, YDCN-500-1P from Kukdo Chemical; as cresol novolak-based epoxy resin, EOCN-102S, EOCN-103S, EOCN-104S, EOCN-1012, EOCN-1025, EOCN-1027 from Japan Explosives Co., Ltd.; and as cresol novolak-based epoxy resin, YDCN-701, YDCN-702, YDCN-703, YDCN-704, YDCN-701P, YDCN-702P, YDCN-703P, YDCN-704P, YDCN-701S, YDCN-702S, YDCN-703S, etc. from Dongdo Chemical Industry. Further, examples of phenol novolak based epoxy resins may include YDPN-638A80, YDPN-644, YDPN-637, YDPN-636, YDPN-638, and YDPN-631, etc.

The silicone resin may include a solvent-added resin, a solvent condensed resin, a solvent ultraviolet-curable resin, a solvent-free addition-type resin, a solvent-free condensation-type resin, a solvent-free ultraviolet-curable resin, a solvent-free electron beam-curable resin, or combinations thereof.

A average particle diameter of the near-infrared ray blocking agent may be 10 to 100 nm.

The near-infrared ray blocking agent may contain 0.5 to 8 parts by weight of tungsten oxide based on 100 parts by weight of the adhesive resin. When the content of the tungsten oxide is within the above range, an adhesive film having the visible-ray transmittance of 80 to 95% in the wavelength band of 400 to 700 nm, the near-infrared ray transmittance of 10 to 70% in the wavelength band of 800 to 1,500 nm, the near-infrared ray transmittance of 15 to 75% in the wavelength band of 800 to 1,000 nm, and the near-infrared ray transmittance of 5 to 69% in the wavelength band of above 1,000 nm and below 1,500 nm may be obtained.

The tungsten oxide may include CWO (cesium-doped WO₃), WO₃, or a combination thereof.

However, the near-infrared ray blocking agent may not contain antimony-containing tin oxide fine particles (ATO), indium-containing tin oxide fine particles (ITO), or a combination thereof. When the near-infrared ray blocking agent contains ATO, ITO, or a combination thereof, the near-infrared ray transmittance may decrease.

The near-infrared ray blocking agent may further contain 0.1 to 0.5 parts by weight of a near-infrared ray blocking additive selected from a group consisting of organic near-infrared ray blocking additive and inorganic near-infrared ray blocking additive based on 100 parts by weight of the adhesive resin. When the content of the near-infrared ray blocking additive is within the above range, an adhesive film having the visible-ray transmittance of 80 to 95% in the wavelength band of 400 to 700 nm, the near-infrared ray transmittance of 10 to 70% in the wavelength band of 800 to 1,500 nm, the near-infrared ray transmittance of 15 to 75% in the wavelength band of 800 to 1,000 nm, and the near-infrared ray transmittance of 5 to 69% in the wavelength band of above 1,000 nm and below 1,500 nm may be obtained.

The organic near-infrared ray blocking additive may include NIR 949C from QCR, ADS series (see https://adsdyes.com/product-category/nir_dyes/) from American Dye Source, or a combination thereof.

The inorganic near-infrared ray blocking additive may include LaB₆, CusSO₄, or a combination thereof.

When necessary, the adhesive film may include polymerization inhibitors such as methylhydroquinone, hydroquinone, 2,2-methylene-bis(4-methyl-6-tertbutylphenol), catechol, hydro-8-quinone monomethyl ether, mono-tert butylhydroquinone, 2,5-di-tertbutylhydroquinone, p-benzoquinone, 2,5-diphenyl-p-benzoquinone, 2,5-di-tertbutyl-p-benzoquinone, picric acid, citric acid, phenothiazine, tertbutylcatechol, 2-butyl-4-hydroxyanisole and 2,6-di-tertbutyl-p-cresol; various elastomers such as acrylic rubber, urethane rubber, and acrylonitrile-butadiene-styrene rubber; inorganic filler; solvent; extender; reinforcement agent; plasticizer; thickener; additional dyes; pigment; flame retardant; silane coupling agent; surfactants or combinations thereof.

The adhesive film may be prepared by curing a curable adhesive composition containing the adhesive resin, the near-infrared ray blocking agent, a curing agent, and optionally other additives.

The curing agent serves to accelerate curing of the curable adhesive composition.

The curing agent may include a thermal curing agent, a photopolymerization initiator, or a combination thereof.

The thermal curing agent may include iodonium salts such as diphenyliodonium⋅hexafluorophosphate, diphenyliodonium⋅hexafluoroantimonate, diphenyliodonium⋅tetrafluoroborate, diphenyliodonium⋅tetrakis(pentafluorophenyl)borate, bis(dodecylphenyl)iodonium⋅hexafluorophosphate, bis(dodecylphenyl)iodonium⋅hexafluoroantimonate, bis(dodecylphenyl)iodonium⋅tetrafluoroborate, bis(dodecylphenyl)iodonium tetrakis(pentafluorophenyl)borate, 4-methylphenyl-4-(1-methylethyl)phenyliodonium⋅hexafluorophosphate, 4-methylphenyl-4-(1-methylethyl)phenyliodonium⋅hexafluoroantimonate, 4-methylphenyl-4-(1-methylethyl)phenyliodonium⋅tetrafluoroborate, 4-methylphenyl-4-(1-methylethyl)phenyliodonium⋅tetrakis(pentafluorophenyl)borate, 4-methoxydiphenyliodonium⋅hexafluorophosphate, bis(4-methylphenyl)iodonium⋅hexafluorophosphate, bis(4-t-butylphenyl)iodonium⋅hexafluorophosphate and bis(dodecylphenyl)iodonium⋅tricumyliodonium hexafluorophosphate; sulfonium salts such as triallyl sulfonium hexafluoro antimonate; phosphonium salts such as triphenylpyrenylmethylphosphonium salt; (η6-benzene)(η5-cyclopentadienyl)iron(II) hexafluoroantimonate; combination of o-nitrobenzylsilyl ether and aluminum acetylacetonate; combination of silsesquioxane and aluminum acetylacetonate; melamine based resin; organic peroxides (e.g. ketone peroxide, peroxy ketal, diacyl peroxide, peroxy ester, peroxydicarbonate, etc.), lewis acid (boron trifluoride, zinc chloride, aluminum chloride, iron chloride, tin chloride, etc.), azo compounds (azobisisobutyronitrile, 1,1′-azobis(cyclohexanecarbonitrile), etc.), acids (organic acids or sulfonium salt-based acid generators that generate acids via low temperature heating, etc.), bases (polyamines such as aliphatic polyamines, amine compounds such as imidazole, hydrazide and ketimine, compounds that generate amine compounds via low temperature heating, etc.), polyamide resin, polymercaptan, platinum group metal compound or complex thereof (platinum chloride (IV), chloroplatinic acid hexahydrate, bis(alkynyl)bis(triphenylphosphine)platinum complex, etc.), or combinations thereof. The thermal curing agent as commercially available products may include 45S (Burim Chemical), DS-HF 10929TKI CATALYST (Teikoku Ink Preparation Co., Ltd., melamine resin).

The photopolymerization initiator may include benzophenone or a derivative thereof, benzyl or a derivative thereof, anthraquinone or a derivative thereof, benzoin, benzoin derivatives such as benzoin methyl ether, benzoin ethyl ether, benzoin propyl ether, benzoin isobutyl ether and benzyl dimethyl ketal, acetophenone derivatives such as diethoxyacetophenone, 4-t-butyltrichloroacetophenone, 2-dimethylaminoethylbenzoate, p-dimethylaminoethylbenzoate, diphenyldisulfide, thioxanthone and derivatives thereof, campoquinone, campoquinone derivatives such as 7,7-dimethyl-2,3-dioxobicyclo[2.2.1]heptane-1-carboxylic acid, 7,7-dimethyl-2,3-dioxobicyclo[2.2.1]heptane-1-carboxy-2-bromoethylester, 7,7-dimethyl-2,3-dioxobicyclo[2.2.1]heptane-1-carboxy-2-methylester, 7,7-dimethyl-2,3-dioxobicyclo[2.2.1]heptane-1-carboxylic acid chloride; alpha-aminoalkylphenone derivatives such as 2-methyl-1-[4-(methylthio)phenyl]-2-morpholinopropan-1-one, 2-benzyl-2-dimethylamino-1-(4-morpholinophenyl)-butanone-1, acylphosphine oxide derivatives such as benzoyldiphenylphosphine oxide, 2,4,6-trimethylbenzoyldiphenylphosphine oxide, benzoyldiethoxyphosphine oxide, 2,4,6-trimethylbenzoyldimethoxyphenylphosphine oxide and 2,4,6-trimethylbenzoyldiethoxyphenylphosphine oxide, or combinations thereof.

Another aspect of the present disclosure provides a laminate film including the adhesive film.

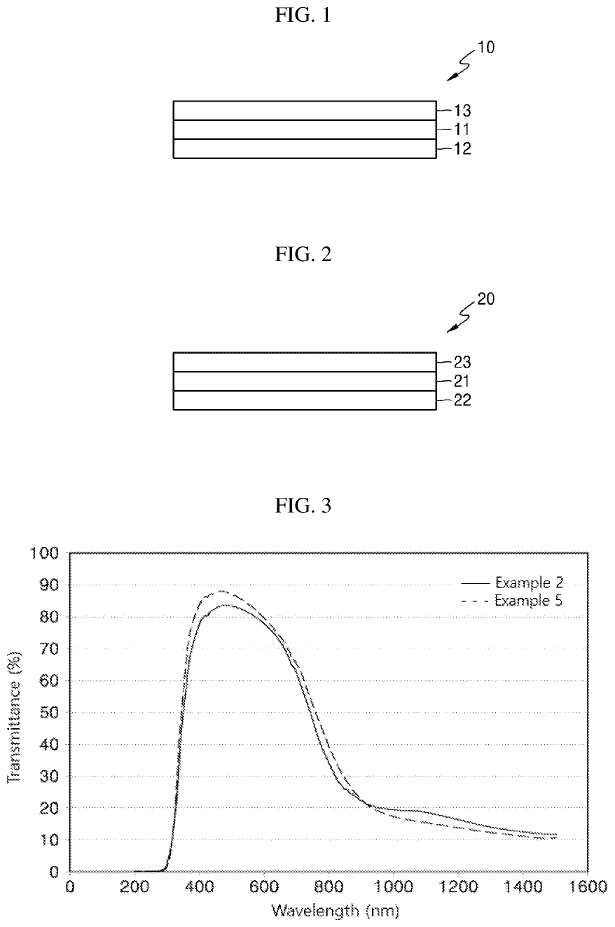

FIG. 1 is a cross-sectional view of a laminate film 10 according to a first embodiment of the present disclosure.

Referring to FIG. 1, the laminate film 10 may include an adhesive film 11, a first release film 12 disposed on one face thereof, and a second release film 13 disposed on an opposite face thereof to one face.

In case of the laminate film 10, only the adhesive film 11 may be used after both the first release film 12 and the second release film 13 are separated from the adhesive film 11.

FIG. 2 is a cross-sectional view of a laminate film 20 according to a second embodiment of the present disclosure.

Referring to FIG. 2, the laminate film 20 may include an adhesive film 21, a transparent base film 22 disposed on one face thereof, and a release film 23 disposed on an opposite face thereof to one face.

When using the laminate film 20, the release film 23 may be separated from the adhesive film 21, and the adhesive film 21 and the transparent base film 22 may be used in a state attached to each other.

Hereinafter, the present disclosure will be described in more detail with examples, but the present disclosure is not limited to these examples.

### Examples 1 to 8 and Comparative Examples 1 to 6

(Preparation of Thermosetting Adhesive Composition)

A thermosetting adhesive composition was prepared by mixing adhesive resin (AR), at least one near-infrared ray blocking agent (NIR-A) and curing agent (PI). A type and content of each of the components are summarized and shown in Table 1 below.

TABLE 1

| | | NIR-A | | | |
|---|---|---|---|---|---|
| Examples | AR | NIR-A1 | NIR-A2 | NIR-A3 | PI |
| Example 1 | 100 | 0.5 | 0 | 0 | 1 |
| Example 2 | 100 | 4 | 0 | 0 | 1 |
| Example 3 | 100 | 8 | 0 | 0 | 1 |
| Example 4 | 100 | 0 | 0.5 | 0 | 1 |
| Example 5 | 100 | 0 | 4 | 0 | 1 |
| Example 6 | 100 | 0 | 8 | 0 | 1 |
| Example 7 | 100 | 4 | 0 | 0.1 | 1 |
| Example 8 | 100 | 4 | 0 | 0.5 | 1 |
| Comparative | 100 | 0.3 | 0 | 0 | 1 |
| Example 1 | | | | | |
| Comparative | 100 | 10 | 0 | 0 | 1 |
| Example 2 | | | | | |
| Comparative | 100 | 0 | 0.3 | 0 | 1 |
| Example 3 | | | | | |
| Comparative | 100 | 0 | 10 | 0 | 1 |
| Example 4 | | | | | |
| Comparative | 100 | 0.3 | 0 | 0.01 | 1 |
| Example 5 | | | | | |
| Comparative | 100 | 10 | 0 | 1 | 1 |
| Example 6 | | | | | |

AR (adhesive resin): Burim Chemical, BA8900
NIR-Al (CWO): Sumitomo Metal Mining, YMF-02A (solid content 28.5%, CWO content 18.5%)
NIR-A2 (WO₃): NST, N2B9 (solid content 23%, WO₃ content 15%)
NIR-A3 (organic near-infrared ray absorbing dye): American dye source, NIR949C
PI (thermal curing agent): Burim Chemical, 45S

(Preparation of Adhesive Film)

Each of the thermosetting adhesive compositions as prepared in Examples 1 to 8 and Comparative Examples 1 to 6 at a thickness of 25 μm was applied to a polyethylene terephthalate (PET) film and then was subjected to curing via heating at 120° C. for 5 minutes and aging at 60° C. for 3 days. Thus, each adhesive film was prepared.

### Evaluation Example

Adhesion, visible-ray transmittance, and near-infrared ray transmittance of each of the adhesive films as prepared in Examples 1 to 8 and Comparative Examples 1 to 6 were evaluated in a following manner, and results are shown in Table 2 below.

<Adhesion Measurement>

Each of the above adhesive films was attached to a non-alkali glass using a 2 kg hand roller. Then, the adhesive film was allowed to be left at room temperature for 24 hours, and then peeled from the glass at 180° at a rate of 300 mm per minute to measure adhesion.

<Optical Transmittance Measurement>

Using a UV-Vis-NIR spectrometer (Jasco, V670), transmittance for each wavelength was measured in the wavelength range of 400 to 1,500 nm. Further, FIG. 3 shows an optical transmittance measurement result based on a wavelength of each of adhesive layers as prepared in Examples 2 and 5.

<Visible-Ray Transmittance Measurement>

Using a UV-Vis-NIR spectrometer (Jasco, V670), transmittance for each wavelength was measured in a wavelength band of 400 to 700 nm, and an average value thereof was recorded as visible-ray transmittance.

<Near-Infrared Ray Transmittance Measurement>

Using a UV-Vis-NIR spectrometer (Jasco, V670), transmittance for each wavelength was measured in a specific wavelength band of 800 to 1,500 nm, and then an average value thereof was recorded as near-infrared ray transmittance (%). A value obtained by subtracting the recorded near-infrared ray transmittance (%) from 100(%) was recorded as resulting near-infrared ray transmittance.

TABLE 2

| | | | Near-infrared ray transmittance (%) | | |
|---|---|---|---|---|---|
| | Adhesion | Visible-ray | | | above 1,000 nm |
| Examples | (gf/inch) | transmittance (%) | 800 to 1,500 nm | 800 to 1,000 nm | and below 1,500 nm |
| Example 1 | 1,740 | 94.9 | 68.9 | 72.5 | 67.4 |
| Example 2 | 1,310 | 89.4 | 19.5 | 25.3 | 17.4 |
| Example 3 | 1,200 | 80.1 | 10.1 | 14.8 | 6.9 |
| Example 4 | 1,580 | 95.0 | 69.6 | 73.9 | 68.1 |
| Example 5 | 1,230 | 89.6 | 20.4 | 27.1 | 19.2 |
| Example 6 | 1,010 | 80.3 | 11.6 | 16.3 | 8.5 |
| Example 7 | 1,230 | 88.1 | 18.0 | 23.6 | 16.2 |
| Example 8 | 1,170 | 83.2 | 13.3 | 18.1 | 10.3 |
| Comparative | 1,820 | 98.9 | 87.6 | 90.3 | 86.2 |
| Example 1 | | | | | |
| Comparative | 1,130 | 72.1 | 1.2 | 1.7 | 0.9 |
| Example 2 | | | | | |
| Comparative | 1,650 | 99.2 | 88.2 | 90.8 | 87.0 |
| Example 3 | | | | | |
| Comparative | 880 | 74.3 | 1.5 | 2.1 | 1.2 |
| Example 4 | | | | | |
| Comparative | 1,700 | 98.7 | 87.3 | 89.9 | 85.8 |
| Example 5 | | | | | |
| Comparative | 1,090 | 62.4 | 0.5 | 0.7 | 0.3 |
| Example 6 | | | | | |

Referring to Table 2, each of the adhesive films as prepared in Examples 1 to 8 has excellent adhesion. Further, all of visible-ray transmittance, near-infrared ray transmittance in the wavelength band of 800 to 1,500 nm, the near-infrared ray transmittance in the wavelength band of 800 to 1,000 nm, and the near-infrared ray transmittance of the wavelength band of above 1,000 nm and below 1,500 nm were within a target numerical range.

On the other hand, each of the adhesive films prepared in Comparative Examples 1 to 3 and Comparative Examples 5 to 6 has excellent adhesion. However, at least three of visible-ray transmittance, near-infrared ray transmittance in the wavelength band of 800 to 1,500 nm, the near-infrared ray transmittance in the wavelength band of 800 to 1,000 nm, and the near-infrared ray transmittance of the wavelength band of above 1,000 nm and below 1,500 nm were not within a target numerical range.

Further, the adhesive film prepared in Comparative Example 4 has low adhesion. Further, all of visible-ray transmittance, near-infrared ray transmittance in the wavelength band of 800 to 1,500 nm, the near-infrared ray transmittance in the wavelength band of 800 to 1,000 nm and the near-infrared ray transmittance of the wavelength band of above 1,000 nm and below 1,500 nm were not within a target numerical range.

The present disclosure has been described with reference to drawings and examples, which are only illustrative. Those of ordinary skill in the art will understand that various modifications and equivalent other embodiments are possible therefrom. Therefore, the true technical protection scope of the present disclosure should be determined based on the technical idea of the attached claims.
10, 20: a laminate film
11, 21: an adhesive film
12, 13, 23: a release film
22: a transparent base film

What is claimed is:

1. An adhesive film containing an adhesive resin and a near-infrared ray blocking agent, wherein visible-ray transmittance of the adhesive film in a wavelength band of 400 to 700 nm is in a range of 80 to 95%, and near-infrared ray transmittance of the adhesive film in a wavelength band of 800 to 1,500 nm is in a range of 10 to 70%.

2. The adhesive film of claim 1, wherein near-infrared ray transmittance of the adhesive film in a wavelength band of above 1,000 nm and below 1,500 nm is in a range of 5 to 69%.

3. The adhesive film of claim 1, wherein near-infrared ray transmittance of the adhesive film in a wavelength band of 800 to 1,000 nm is in a range of 15 to 75%.

4. The adhesive film of claim 1, wherein the adhesive resin includes a urethane resin, an acrylic resin, an epoxy resin, a silicone resin, or combinations thereof.

5. The adhesive film of claim 1, wherein an average particle diameter of the near-infrared ray blocking agent is in a range of 10 to 100 nm.

6. The adhesive film of claim 1, wherein the near-infrared ray blocking agent contains 0.5 to 8 parts by weight of tungsten oxide based on 100 parts by weight of the adhesive resin.

7. The adhesive film of claim 6, wherein the tungsten oxide includes CWO (cesium-doped WO₃), WO₃, or a combination thereof.

8. The adhesive film of claim 6, wherein the near-infrared ray blocking agent further comprises 0.1 to 0.5 parts by weight of a near-infrared ray blocking additive selected from a group consisting of an organic near-infrared ray blocking additive and an inorganic near-infrared ray blocking additive, based on 100 parts by weight of the adhesive resin.

9. A laminate film comprising the adhesive film of claim 1.

10. The laminate film of claim 9, wherein the laminate film comprises a pair of release films including a first release film disposed on one face of the adhesive film and a second release film disposed on an opposite face of the adhesive film to one face.

11. The laminate film of claim 10, wherein each of the first and second release films includes polyethylene terephthalate (PET), triacetyl cellulose (TAC), cycloolefin polymer (COP), polycarbonate (PC), polyethersulfone (PES), polypropylene (PP), acrylic, or combinations thereof.

12. The laminate film of claim 10, wherein a peel force between the adhesive film and each of the release films is in a range of 1 to 20 gf/inch.

13. The laminate film of claim 9, wherein the laminate film further comprises a release film disposed on one face of the adhesive film, and a transparent base film disposed on an opposite face thereof to one face.

14. The laminate film of claim 13, wherein the transparent base film includes polyethylene terephthalate (PET), triacetyl cellulose (TAC), cycloolefin polymer (COP), polycarbonate (PC), polyethersulfone (PES), polypropylene (PP), acrylic, or combinations thereof.

15. The laminate film of claim 13, wherein the transparent base film has an anti-fog coating.

16. The laminate film of claim 9, wherein the laminate film is applicable to an outdoor display or a vehicle.
